(19) United States
(12) Patent Application Publication
(10) Pub. No.: US 2016/0159115 A1
(43) Pub. Date: Jun. 9, 2016

(54) Printing Device

(71) Applicant: Seiko Epson Corporation, Tokyo (JP)

(72) Inventor: Yuki Awanohara, Shiojiri-shi (JP)

(21) Appl. No.: 14/947,744

(22) Filed: Nov. 20, 2015

(30) Foreign Application Priority Data
Dec. 3, 2014 (JP) 2014-244726

(51) Int. Cl. B41J 11/04

(52) U.S. Cl. CPC B41J 11/04

(57) ABSTRACT

The conveyance mechanism 11 of a printer 1 has a conveyance roller 22, and first and second roller segments 23(1), 23(2). The hardness of the first roller segment 23(1) is lower than the hardness of the second roller segment 23(2), and is pushed against the conveyance roller 22 with greater pressure than the second roller segment 23(2). Skewing of the recording paper 3 due to variations in the conveyance roller 22 can therefore be prevented or suppressed because the nip width N1 of contact in the conveyance direction D between the outside surface 23a of the first driven roller 23 and the conveyance roller 22 is greater than the nip width N2 of contact in the conveyance direction D between the outside surface 23a of the second driven roller 23 and the conveyance roller 22.

### BACKGROUND

1. Technical Field

The present disclosure relates to a printing device that prints while conveying recording paper with a conveyance roller and a plurality of driven rollers that are pressed against the conveyance roller.

2. Related Art

JP-A-2012-56224 discloses a printing device that prints on continuous paper and other types of recording paper. The printing device in JP-A-2012-56224 has a conveyance path that passes the printing position of the printhead, and a conveyance mechanism that conveys the recording paper through the conveyance path. The conveyance mechanism includes a conveyance roller, and a plurality of driven rollers that are arranged along the axis of rotation of the conveyance roller and are pressed against the conveyance roller. The printhead is disposed on the downstream side of the conveyance roller in the conveyance direction of the recording paper.

In a conveyance mechanism that conveys recording paper by a conveyance roller, the conveyed recording paper may become skewed when the outside diameter of the conveyance roller is not constant due to manufacturing tolerances, or the axis of rotation of the conveyance roller is offset from the design axis. When the recording paper is skewed as it passes the printing position, print quality drops.

### SUMMARY

A printing device according to the disclosure prevents or suppresses skewing of the recording paper when the recording paper is conveyed by a conveyance roller.

A printing device according to a preferred aspect of the invention has a printhead that prints on recording paper; a conveyance roller that conveys the recording paper; and a first driven roller and a second driven roller disposed along the axis of rotation of the conveyance roller and pressed against the conveyance roller, the nip width of contact between the first driven roller surface and the conveyance roller being different from the nip width of contact between the second driven roller surface and the conveyance roller.

The conveyed recording paper may become skewed when the outside diameter of the conveyance roller is not constant due to manufacturing tolerances, or the axis of rotation of the conveyance roller is offset from the design axis.

Because the nip width (length of the nipping surface in the conveyance direction of the recording paper) of contact between the surface of the first driven roller and the surface of the conveyance roller is different from the nip width of contact between the surface of the second driven roller and the surface of the conveyance roller, conveyance of the recording paper at the part where the recording paper is conveyed by the conveyance roller and the first driven roller can be made different from the conveyance of the recording paper at the part where the recording paper is conveyed by the conveyance roller and the second driven roller. The recording paper can therefore be conveyed in the direction cancelling skewing due to manufacturing variations in the conveyance roller.

For example, when the nip width of contact between the surface of the first driven roller and the surface of the conveyance roller is greater than the nip width of contact between the surface of the second driven roller and the surface of the conveyance roller, slipping of the recording paper in the nip width of the conveyance roller and the first driven roller is suppressed. Conveyance of the recording paper in this part is therefore greater than conveyance of the recording paper in the nip width of the conveyance roller and the second driven roller. As a result, the part of the conveyed recording paper on the upstream side in the conveyance direction can be pushed to one side in the crosswise direction (the side of the first driven roller), and the part of the conveyed recording paper on the downstream side in the conveyance direction can be pushed to the other side in the crosswise direction. The recording paper therefore can be conveyed while cancelling skewing when the conveyed recording paper becomes skewed to one side crosswise downstream in the conveyance direction (to the side of the first driven roller).

Therefore if the nip width of the first driven roller and conveyance roller and the nip width of the second driven roller and the conveyance roller are different, skewing of the recording paper when the recording paper is conveyed by the conveyance roller can be prevented or suppressed.

A printing device according to another aspect of the invention preferably also has a paper guide that contacts an edge of the recording paper in the direction of the axis of rotation, and guides the recording paper in a predetermined conveyance direction.

Thus comprised, skewing of the recording paper can be prevented by conveying the recording paper against the paper guide.

In a printing device according to another aspect of the invention, the first driven roller and the second driven roller each have a roller body with an outside surface; and the hardness of the roller body of the first driven roller, and the hardness of the roller body of the second driven roller, are different.

For example, if the hardness of the roller body of the first driven roller is lower than the hardness of the roller body of the second driven roller, the first driven roller deforms more than the second driven roller. The nip width of contact between the surface of the first driven roller and the surface of the conveyance roller can therefore be made greater than the nip width of contact between the surface of the second driven roller and the surface of the conveyance roller. If the nip width of contact between the driven roller and the conveyance roller increases, slipping of the recording paper against rotation of the conveyance roller can be suppressed.

Therefore, if the hardness of the roller body of the first driven roller is lower than the hardness of the roller body of the second driven roller, conveyance of the recording paper at the part where the recording paper is conveyed by the conveyance roller and the first driven roller is greater than conveyance of the recording paper at the part where the recording paper is conveyed by the conveyance roller and the second driven roller. As a result, the part of the conveyed recording paper on the upstream side in the conveyance direction can be pushed to one side in the crosswise direction (the side of the first driven roller), and the part of the conveyed recording paper on the downstream side in the conveyance direction can be pushed to the other side in the crosswise direction. The recording paper can therefore be conveyed while cancelling skewing when the conveyed recording paper becomes skewed to one side crosswise downstream in the conveyance direction (to the side of the first driven roller).

Furthermore, if a paper guide is provided on the side to which the recording paper is pushed during conveyance, the recording paper can be conveyed while held in contact with the paper guide. Skewing of the recording paper can therefore be prevented.

In a printing device according to another aspect of the invention, the coefficient of friction of the roller surface of the first driven roller, and the coefficient of friction of the roller surface of the second driven roller, are different.

For example, if the coefficient of friction of the roller body of the first driven roller is greater than the coefficient of friction of the roller body of the second driven roller, slipping of the recording paper where the recording paper is conveyed by the first driven roller can be suppressed, and conveyance of the recording paper in this part can be increased compared with conveyance of the recording paper where the recording paper is conveyed by the conveyance roller and the second driven roller. As a result, the part of the conveyed recording paper on the upstream side in the conveyance direction can be pushed to one side in the crosswise direction (the side of the first driven roller), and the part of the conveyed recording paper on the downstream side in the conveyance direction can be pushed to the other side in the crosswise direction.

In a printing device according to another aspect of the invention, the roller diameter of the first driven roller, and the roller diameter of the second driven roller, are different. More specifically, the radius of curvature of the outside surface of the first driven roller and the radius of curvature of surface of the second driven roller can differ. For example, if the diameter of the first driven roller is greater than the diameter of the second driven roller, the area (nip width) of contact between the conveyance roller and the surface of the first driven roller is greater than the area (nip width) of contact between the conveyance roller and the surface of the second driven roller. Slipping of the recording paper where the recording paper is conveyed by the first driven roller can therefore be suppressed, and conveyance of the recording paper in this part can be made greater than conveyance of the recording paper where the recording paper is conveyed by the conveyance roller and the second driven roller. As a result, the part of the conveyed recording paper on the upstream side in the conveyance direction can be pushed to one side in the crosswise direction (the side of the first driven roller), and the part of the conveyed recording paper on the downstream side in the conveyance direction can be pushed to the other side in the crosswise direction.

A printing device according to another aspect of the invention preferably also has a first pressure mechanism that pushes the first driven roller with a first pressure against the conveyance roller; and a second pressure mechanism that pushes the second driven roller with a second pressure against the conveyance roller; and the first pressure and the second pressure are different.

If the first pressure is greater than the second pressure, slipping of the recording paper where the recording paper is conveyed by the first driven roller can be suppressed, and conveyance of the recording paper in this part can be made greater than conveyance of the recording paper where the recording paper is conveyed by the conveyance roller and the second driven roller. The first driven roller that is pressed to the conveyance roller with the larger first pressure also deforms more than the second driven roller pressed against the conveyance roller with the second pressure. The area (nip width) of contact between the conveyance roller and the surface of the first driven roller can therefore be made greater than the area (nip width) of contact between the conveyance roller and the surface of the second driven roller. Conveyance of the recording paper in the part conveyed by the conveyance roller and the first driven roller can therefore be made greater than conveyance of the recording paper where the recording paper is conveyed by the conveyance roller and the second driven roller. As a result, the part of the conveyed recording paper on the upstream side in the conveyance direction can be pushed to one side in the crosswise direction (the side of the first driven roller), and the part of the conveyed recording paper on the downstream side in the conveyance direction can be pushed to the other side in the crosswise direction.

A printing device according to another aspect of the invention preferably also has: a first pressure mechanism that pushes the first driven roller with a first pressure against the conveyance roller; and a second pressure mechanism that pushes the second driven roller with a second pressure against the conveyance roller. The first driven roller is disposed on one side of the second driven roller in the direction of the axis of rotation; the first driven roller and the second driven roller each have a roller body with an outside surface; the hardness of the roller body of the first driven roller is lower than the hardness of the roller body of the second driven roller; the first pressure is greater than the second pressure; the area of contact between the surface of the first driven roller and the conveyance roller is greater than the area of contact between the surface of the second driven roller and the conveyance roller; and the paper guide is disposed upstream in the conveyance direction from the conveyance roller in contact with the edge of the recording paper on one side in the direction of the axis of rotation.

Slipping of the recording paper where the recording paper is conveyed by the first driven roller can therefore be suppressed, and conveyance of the recording paper in this part can be made greater than conveyance of the recording paper where the recording paper is conveyed by the conveyance roller and the second driven roller. As a result, the part of the conveyed recording paper on the upstream side in the conveyance direction can be pushed to one side in the crosswise direction (the side of the first driven roller), and the part of the conveyed recording paper on the downstream side in the conveyance direction can be pushed to the other side in the crosswise direction.

In a printing device according to another aspect of the invention, the printhead is disposed downstream in the conveyance direction from the conveyance roller.

Skewing of the recording paper conveyed past the printing position of the printhead can therefore be prevented or suppressed.

Other objects and attainments together with a fuller understanding of the invention will become apparent and appreciated by referring to the following description and claims taken in conjunction with the accompanying drawings.

### BRIEF DESCRIPTION OF THE DRAWINGS

FIGS. 1A and 1B are a schematic vertical section view and plan view respectively of a printer according to the invention.

FIGS. 2A and 2B illustrate a pressure mechanism that urges the roller segments.

FIGS. 3A and 3B illustrate the nip width of the roller segments and conveyance roller

FIGS. 4A, 4B and 4C illustrate the recording paper conveyance operation of the conveyance mechanism.

FIGS. 5A, 5B and 5C illustrate another example of the recording paper conveyance operation of the conveyance mechanism.

### DESCRIPTION OF EMBODIMENTS

A preferred embodiment of a printer according to the present invention is described below with reference to the accompanying figures.

### Basic Configuration

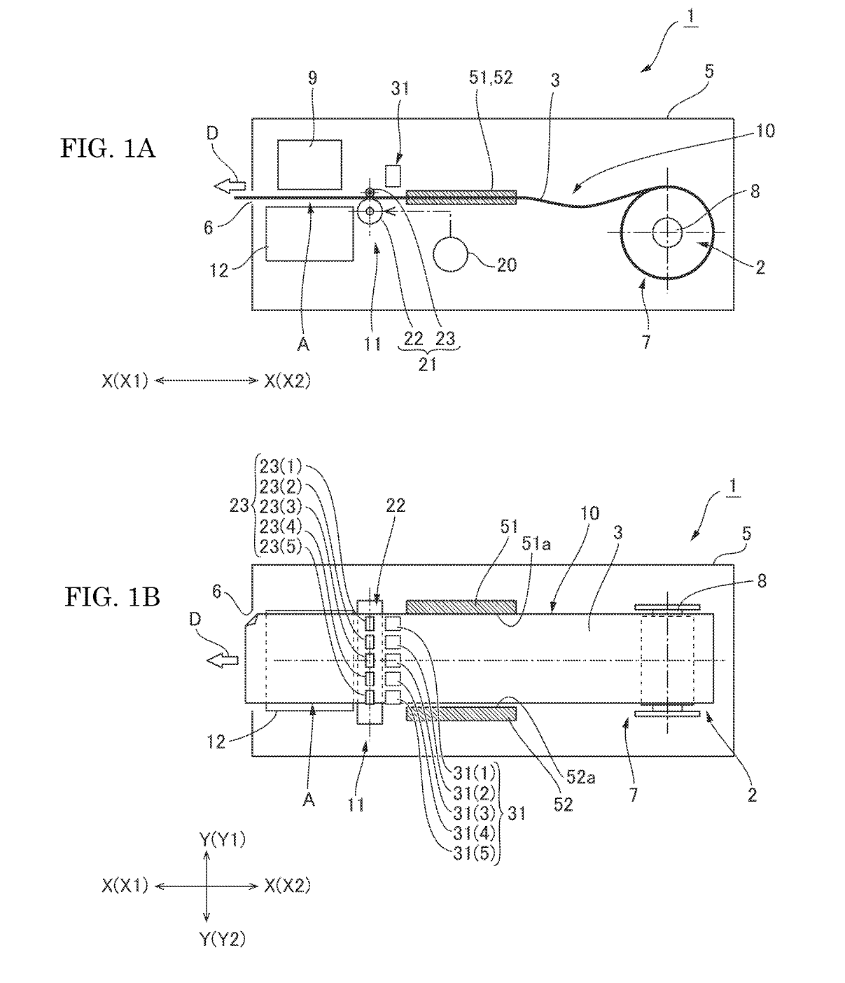

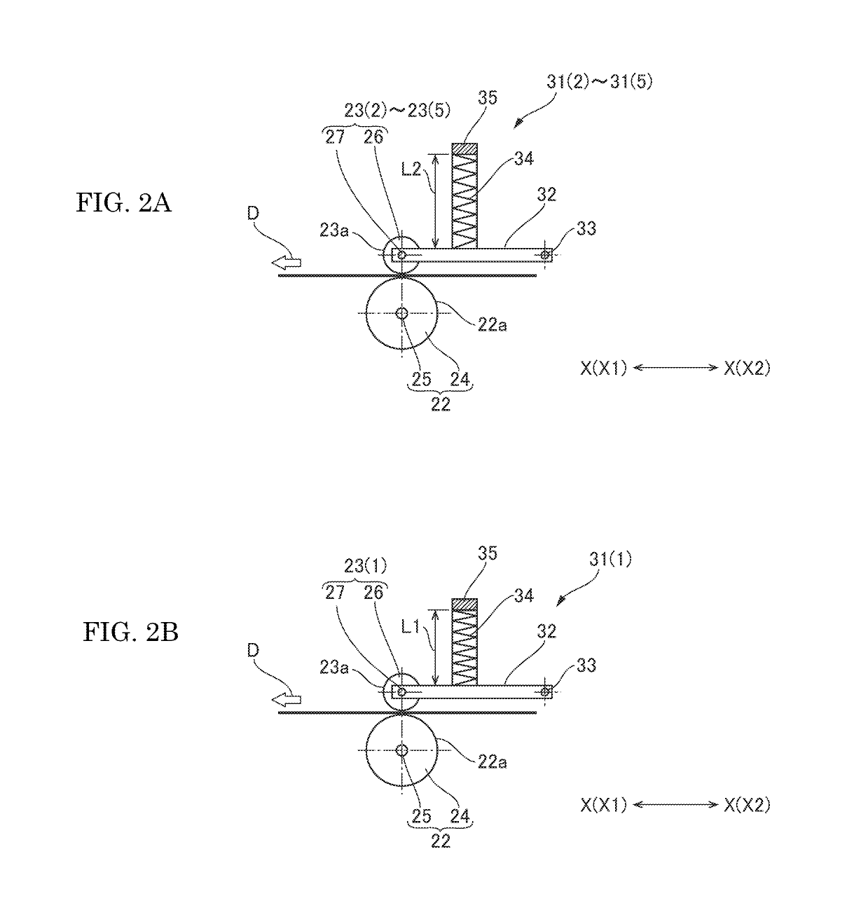

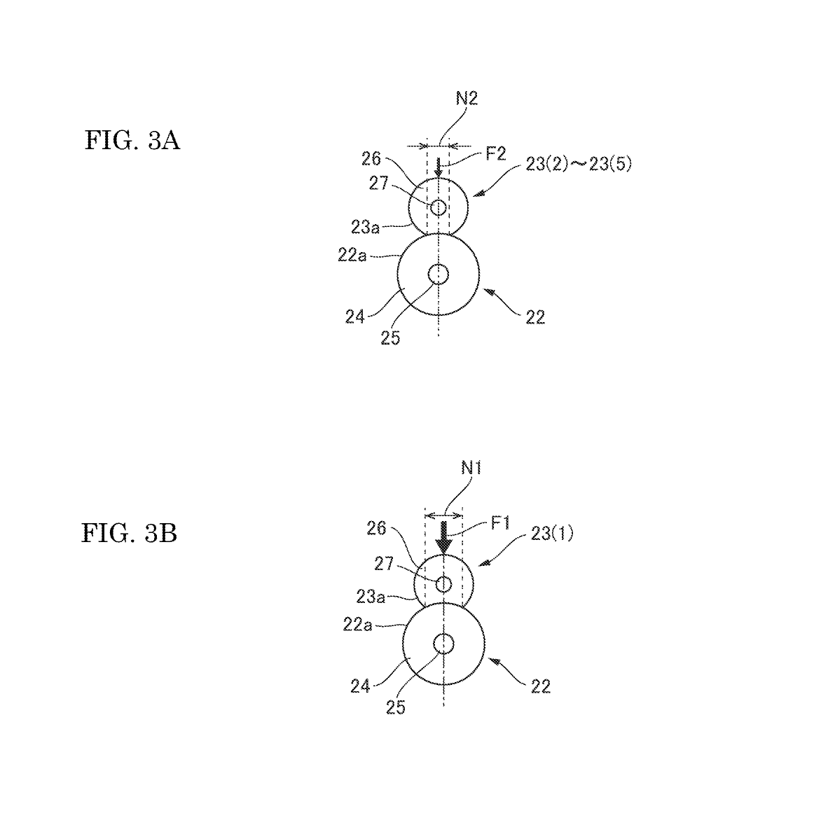

FIG. 1A is a vertical section view of the general configuration of a printer according to the invention, and FIG. 1B is a plan view showing main parts of the printer. The printhead is omitted from FIG. 1B. FIG. 2A illustrates the second to fifth pressure mechanisms, and FIG. 2B illustrates the first pressure mechanism. FIG. 3A illustrates the nip width of each of the second to fifth roller segments and the conveyance roller, and FIG. 3B illustrates the nip width of the first roller segment and the conveyance roller. The printer 1 in this example prints to continuous recording paper 3 delivered from a paper roll 2.

As shown in FIG. 1, the printer 1 has a paper exit 6 from which the recording paper 3 is discharged in the front of the case 5. The printer 1 also has a roll paper compartment 7 to which the paper roll 2 is loaded inside of the case 5 at the back. The paper roll 2 is supported freely rotatably on a roll paper spindle 8 inside the roll paper compartment 7. A conveyance path 10 formed inside the case 5 goes from the roll paper compartment 7 to the paper exit 6 passing the printing position A of the printhead 9. The printer 1 also has a conveyance mechanism 11 that conveys the recording paper 3 pulled from the paper roll 2 through the conveyance path 10 to the printer front X1. Note that the direction the conveyance path 10 travels is referred to below as the longitudinal axis X between the front and back of the printer, the side where the paper exit 6 is located is the printer front X1, and the side where the roll paper compartment 7 is located is the printer back X2.

The direction across the width of the conveyance path 10 is the transverse axis Y, the left side as seen from the front of the printer 1 is the first direction Y1 and the right side is the second direction Y2 on the transverse axis Y.

The printhead 9 in this example is an inkjet head. The printing position A of the printhead 9 is defined by a platen 12 disposed opposite the printhead 9 with a specific gap therebetween.

A conveyance roller pair 21 embodying the conveyance mechanism 11 is disposed on the upstream side (printer back X2) of the printing position A in the conveyance direction D. The conveyance roller pair 21 includes a conveyance roller 22 and a driven roller 23 that nips the recording paper 3 with the conveyance roller 22.

As shown in FIG. 2, the conveyance roller 22 includes a roller body 24 with an outside roller surface 22a, and a roller spindle 25. The outside diameter of the roller body 24 is constant. Drive power from a conveyance motor 20 is transferred to the roller spindle 25, and the conveyance roller 22 is thereby driven rotationally.

The driven roller 23 includes first to fifth roller segments 23(1) to 23(5) (a plurality of driven rollers) disposed along the axis of rotation of the conveyance roller 22. The direction of the axis of rotation of the conveyance roller 22 is the axial direction of the roller spindle 25, and is on the transverse axis Y. The first to fifth roller segments 23(1) to 23(5) each have a roller body 26 with an outside surface 23a, and a roller spindle 27. The diameter of the roller body 26 in each roller segment 23(1) to 23(5) is the same, and is smaller than the diameter of the roller body 24 of the conveyance roller 22. The roller width (length on the transverse axis Y) of the first to fifth roller segments 23(1) to 23(5) is the same, and the five roller segments 23(1) to 23(5) are disposed with equal spacing therebetween.

Of the first to fifth roller segments 23(1) to 23(5), the first roller segment 23(1) (a first driven roller) located at the first direction Y1 end on the transverse axis Y differs from the second to fifth roller segments 23(2) to 23(5) (a second driven roller). In this example, the hardness of the roller body 26 is the same in each of the second to fifth roller segments 23(2) to 23(5), and the hardness of the roller body 26 in the first roller segment 23(1) is lower than the hardness of the roller body 26 is the second to fifth roller segments 23(2) to 23(5).

The first to fifth roller segments 23(1) to 23(5) are pushed against the conveyance roller 22 by first to fifth pressure mechanisms 31(1) to 31(5) disposed above the conveyance path 10. The pressure mechanisms 31(1)-31(5) exert pressure pushing the corresponding roller segments 23(1)-23(5) to the conveyance roller 22.

As shown in FIG. 2, each pressure mechanism 31(1)-31(5)has a support arm 32 that rotatably supports the corresponding roller segment 23(1)-23(5) at the printer front X1 end; a support shaft 33 extending parallel to the roller spindle 25 of the conveyance roller 22 (parallel to the axis of rotation of the conveyance roller 22) and rotatably supporting the support arm 32 at the printer back X2 end; and a coil spring 34 (pressure member) that pushes down on the support arm 32 at a position between the front and back ends. The support shaft 33 is located on the upstream side in the conveyance direction D from the roller spindle 25 (axis of rotation) of the conveyance roller 22.

As shown in FIG. 3, each of the second to fifth pressure mechanisms 31(2)-31(5) applies the same pressure (second pressure) F2 to the second to fifth roller segments 23(2) to 23(5). The pressure (first pressure Fl) that the first pressure mechanism 31(1) applies to the first roller segment 23(1) is greater than the second pressure F2 the second to fifth pressure mechanisms 31(2)-31(5) apply.

More specifically, the coil spring 34 that exerts pressure on the first to fifth pressure mechanisms 31(1) to 31(5) is compressed between the support arm 32 and a stop 35, but the distance L1 between the support arm 32 and stop 35 in the first pressure mechanism 31(1) shown in FIG. 2B is shorter than the distance L2 between the support arm 32 and stop 35 in the second to fifth pressure mechanisms 31(2)-31(5) shown in FIG. 2A. The coil spring 34 of the first pressure mechanism 31(1) is therefore compressed more than the coil spring 34 in the other pressure mechanisms, and the first pressure mechanism 31(1) therefore exerts greater pressure Fl than the other pressure mechanisms 31(2)-31(5).

As described above, the hardness of the roller body 26 in the first roller segment 23(1) is lower than the hardness of the roller body 26 in the second to fifth roller segments 23(2) to 23(5).

Therefore, the first roller segment 23(1) deforms more easily than the second to fifth roller segments 23(2) to 23(5). In addition, because the first roller segment 23(1) is pressed to the conveyance roller 22 with greater pressure (force) than the second to fifth roller segments 23(2) to 23(5), the first roller segment 23(1) deforms more than the second to fifth roller segments 23(2) to 23(5).

As a result, the nip width (nip width N1, see FIG. 3B) of contact between the outside surface 23a of the first roller segment 23(1) and the conveyance roller 22 is greater than the nip width (nip width N2, FIG. 3A) of contact between the outside surfaces 23a of the second to fifth roller segments 23(2) to 23(5) and the conveyance roller 22.

The nip width is the length in the conveyance direction D of contact between the outside surface 23a of the first to fifth roller segments 23(1) to 23(5) and the roller surface 22a of the conveyance roller 22. In other words, it is the length in the conveyance direction D that the recording paper 3 is nipped between the first to fifth roller segments 23(1) to 23(5) and the conveyance roller 22. The nip width corresponds to the area of contact between the outside surface 23a of each of the first to fifth roller segments 23(1) to 23(5) and the roller surface 22a of the conveyance roller 22.

Next, as shown in FIG. 1, a pair of paper guides 51, 52 is disposed on the upstream side (printer back X2 side) of the conveyance roller pair 21 in the conveyance direction D. The inside surfaces of the pair of paper guides 51, 52 that face each other on the transverse axis Y are guide surfaces 51a, 52a that can contact the edges of the recording paper 3 on the transverse axis Y. In this example, the paper guide 51 on the first direction Yl side of the pair of paper guides 51, 52 is a reference guide. The guide surface 51a of the paper guide 51 contacts the first direction Y1 edge of the recording paper 3 and guides the recording paper 3 in the conveyance direction D.

### Printing Operation

The printer 1 drives the conveyance mechanism 11 to convey the recording paper 3 through the conveyance path 10, and drives the printhead 9 to print on the recording paper 3 when passing the printing position A. The printer 1 in this example prevents skewing of the recording paper 3 while passing the printing position A, and can therefore maintain print quality.

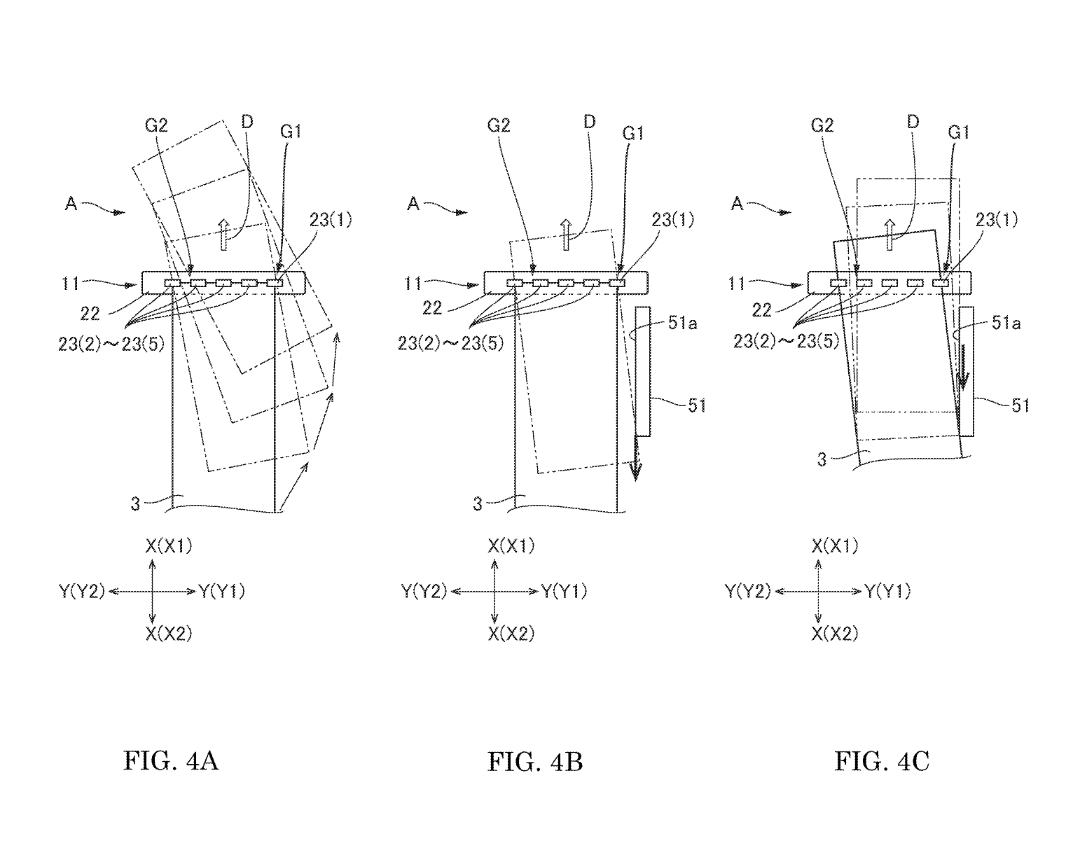

FIG. 4 illustrates the conveyance operation of the conveyance mechanism 11. Why the recording paper 3 does not become skewed while passing the printing position A is described below with reference to FIG. 4.

First, the nip width (nip width N1) of contact in the conveyance direction D between the outside surface 23a of the first roller segment 23(1) and the surface of the conveyance roller 22 is greater than the nip width (nip width N2) of contact in the conveyance direction D between the surface of the conveyance roller 22 and the outside surface 23a of the second to fifth roller segments 23(2) to 23(5). Slipping of the recording paper 3 in the part G1 where the recording paper 3 is conveyed by the cooperation of the conveyance roller 22 and first roller segment 23(1) is therefore suppressed. As a result, conveyance of the recording paper 3 in the part G1 where the recording paper 3 is conveyed by the cooperation of the conveyance roller 22 and first roller segment 23(1) is greater than conveyance of the recording paper 3 in the part G2 where the recording paper 3 is conveyed by the cooperation of the conveyance roller 22 and the second to fifth roller segments 23(2) to 23(5).

Furthermore, because the pressure of the first pressure mechanism 31(1) is greater than the pressure applied by the second to fifth pressure mechanisms 31(2)-31(5), slipping of the recording paper 3 in the part G1 where the recording paper 3 is conveyed is further suppressed by the cooperation of the conveyance roller 22 and first roller segment 23(1). As a result, conveyance of the recording paper 3 in the part G1 where the recording paper 3 is conveyed by the cooperation of the conveyance roller 22 and first roller segment 23(1) is greater than conveyance of the recording paper 3 in the part G2 where the recording paper 3 is conveyed by the cooperation of the conveyance roller 22 and the second to fifth roller segments 23(2) to 23(5).

As a result, the recording paper 3 conveyed by the conveyance mechanism 11 becomes skewed to the second direction Y2 side downstream in the conveyance direction D (to the opposite side as the side where the first roller segment 23(1) is located on the transverse axis Y).

When the conveyed recording paper 3 becomes skewed to the second direction Y2 side downstream in the conveyance direction D, the upstream side of the recording paper 3 in the conveyance direction D goes to the first direction Y1 side, and the downstream side in the conveyance direction D goes to the second direction Y2 side. As a result, as shown in FIG. 4B, the part of the recording paper 3 on the upstream side in the conveyance direction D from the conveyance roller 22 contacts the paper guide 51.

When the recording paper 3 contacts the paper guide 51, a conveyance load in the direction indicated by the arrow in FIG. 4B is applied to the recording paper 3. This conveyance load on the recording paper 3 is high on the first direction Y1 side of the recording paper 3, and low on the second direction Y2 side. As a result, the first direction Yl part of the recording paper 3 slips easily against the conveyance roller 22.

Conveyance of the recording paper 3 by the conveyance roller 22 and first roller segment 23(1) is great at the part of the recording paper 3 on the first direction Y1 side where the conveyance load is great. Conveyance of the recording paper 3 by the conveyance roller 22 and second to fifth roller segments 23(2) to 23(5) is less at the part of the recording paper 3 on the second direction Y2 side where the conveyance load is small. The difference in the conveyance load on the recording paper 3 across the transverse axis Y (the difference in slippage of the recording paper 3 against the conveyance roller 22) is therefore cancelled by the difference in the amount the recording paper 3 is conveyed by the conveyance mechanism 11 across the transverse axis Y, and skewing of the recording paper 3 is corrected. In addition, as shown in FIG. 4C, the first direction Y1 edge of the recording paper 3 contacts the guide surface 51a of the paper guide 51, and the recording paper 3 is thereafter conveyed against the guide surface 51a. Skewing of the recording paper 3 while passing the printing position A can therefore be prevented.

### Other Embodiments

Alternatively, the first to fifth pressure mechanisms 31(1) to 31(5) may apply the same pressure while the hardness of the roller body 26 of the first roller segment 23(1) is lower than the hardness of the roller bodies 26 of the second to fifth roller segments 23(2) to 23(5). In this case, the nip width (nip width N1) of contact in the conveyance direction D between the outside surface 23a of the first roller segment 23(1) and the conveyance roller 22 can be made greater than the nip width (nip width N2) of contact in the conveyance direction D between the outside surfaces 23a of the second to fifth roller segments 23(2) to 23(5) and the conveyance roller 22. The same effect as described above can therefore be achieved.

Further alternatively, the coefficient of friction of the outside surface 23a of the first roller segment 23(1) and the coefficient of friction of the outside surface 23a of the second to fifth roller segments 23(2) to 23(5) may differ. For example, if the coefficient of friction of the outside surface 23a of the first roller segment 23(1) is greater than the coefficient of friction of the outside surface 23a of the second to fifth roller segments 23(2) to 23(5), slipping of the recording paper 3 in the part G1 where the recording paper 3 is conveyed can be suppressed by the cooperation of the conveyance roller 22 and first roller segment 23(1). As a result, conveyance of the recording paper 3 in part G1 is greater than conveyance of the recording paper 3 in the part G2 where the recording paper 3 is conveyed by the cooperation of the conveyance roller 22 and the second to fifth roller segments 23(2) to 23(5). The same effect as described above can therefore be achieved.

The coefficients of friction of the outside surface 23a of the roller segments 23 can be made different by using different materials for the roller bodies 26, or by varying the surface roughness of the outside surfaces 23a.

The roller diameter of the first roller segment 23(1) and the roller diameter of the second to fifth roller segments 23(2) to 23(5) may also differ. In other words, the radius of curvature of the outside surface 23a of the first roller segment 23(1) and the radius of curvature of the second to fifth roller segments 23(2) to 23(5) may differ.

For example, if the roller diameter of the first roller segment 23(1) is greater than the roller diameter of the second to fifth roller segments 23(2) to 23(5), the nip width (nip width N1) of contact in the conveyance direction D between the outside surface 23a of the first roller segment 23(1) and the conveyance roller 22 will be greater than the nip width (nip width N2) of contact in the conveyance direction D between the conveyance roller 22 and the outside surface 23a of the second to fifth roller segments 23(2) to 23(5). Slipping of the recording paper 3 in the part G1 where the recording paper 3 is conveyed by the cooperation of the conveyance roller 22 and first roller segment 23(1) is therefore suppressed. As a result, conveyance of the recording paper 3 in the part G1 is greater than conveyance of the recording paper 3 in the part G2 where the recording paper 3 is conveyed by the cooperation of the conveyance roller 22 and the second to fifth roller segments 23(2) to 23(5). The same effect as described above can therefore be achieved.

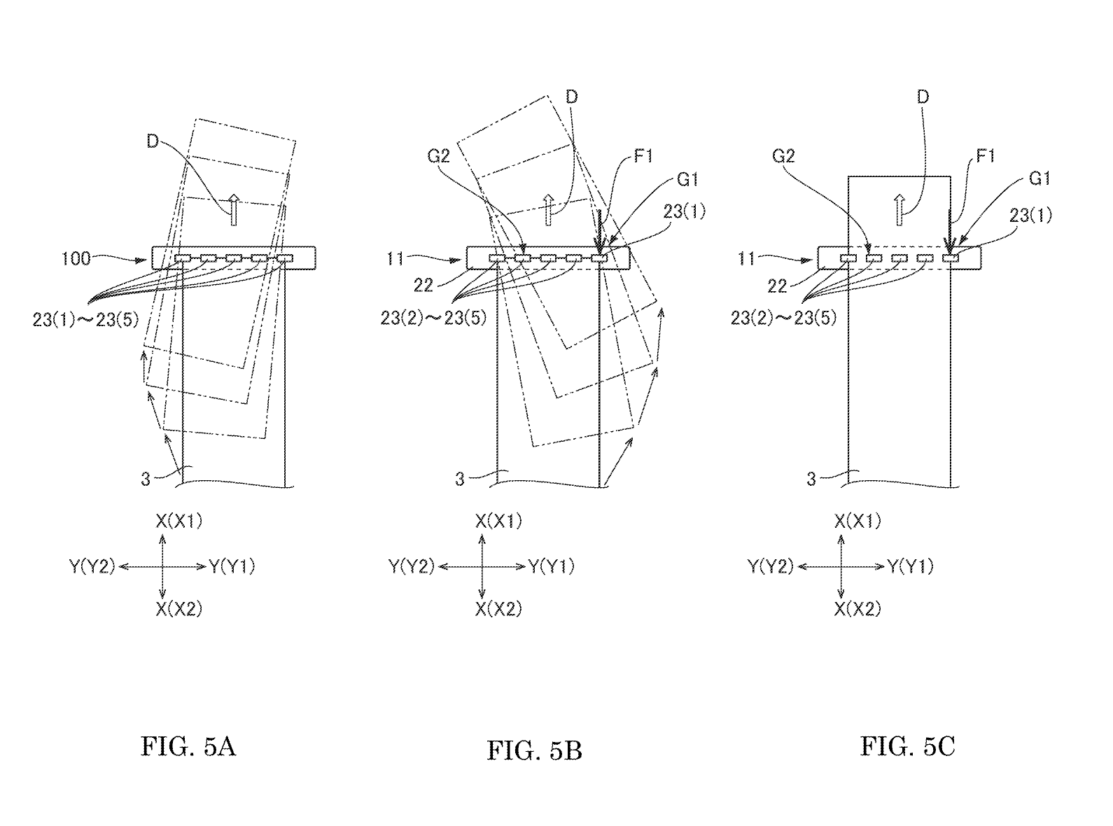

Skewing is prevented in the above examples by the recording paper 3 contacting the paper guide 51, but skewing can also be prevented or suppressed without using a paper guide 51. For example, when the outside diameter of the conveyance roller 22 is not constant due to manufacturing tolerances, or the axis of rotation of the conveyance roller 22 is offset from the design axis, the recording paper 3 conveyed by the conveyance mechanism may become skewed. By using the conveyance mechanism 11 described above in this case, skewing can be prevented or suppressed. FIG. 5 illustrates the conveyance operation of the conveyance mechanism 11 that suppresses such skewing.

In the example shown in FIG. 5A, the recording paper 3 is conveyed by a conveyance mechanism 100. The first to fifth roller segments 23(1) to 23(5) in this conveyance mechanism 100 are identical. The first to fifth pressure mechanisms 31(1) to 31(5) also exert the same pressure. The recording paper 3 conveyed by this conveyance mechanism 100 becomes skewed to the first direction Y1 downstream in the conveyance direction D due to manufacturing differences in the conveyance roller 22.

The conveyance mechanism 11 of the invention is used instead of the conveyance mechanism 100 in this case. More specifically, the hardness of the roller body 26 of the first roller segment 23(1) is changed to a lower hardness, and the pressure of the first pressure mechanism 31(1) is increased.

As a result, the nip width (nip width N1) of contact in the conveyance direction D between the outside surface 23a of the first roller segment 23(1) and the conveyance roller 22 becomes greater than the nip width (nip width N2) of contact in the conveyance direction D between the outside surfaces 23a of the second to fifth roller segments 23(2) to 23(5) and the conveyance roller 22. As a result, conveyance of the recording paper 3 in the part G1 where the recording paper 3 is conveyed by the cooperation of the conveyance roller 22 and first roller segment 23(1) is greater than conveyance of the recording paper 3 in the part G2 where the recording paper 3 is conveyed by the cooperation of the conveyance roller 22 and the second to fifth roller segments 23(2) to 23(5). As a result, using the new conveyance mechanism 11 after adjusting the conveyance mechanism 100, the recording paper 3 becomes skewed to the second direction Y2 side downstream in the conveyance direction D as shown in FIG. 5B. Skewing of the recording paper 3 that occurs in the conveyance mechanism 100 before adjustment can be cancelled by the skew produced by the new conveyance mechanism 11. The recording paper 3 can therefore be conveyed without skew as shown in FIG. 5C.

Thus the invention suppresses skewing of the recording paper 3 without replacing the conveyance roller 22 and without changing the position of the conveyance roller 22.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A printing device comprising:
a printhead that prints on recording paper;
a conveyance roller that conveys the recording paper; and
a first driven roller and a second driven roller disposed along the axis of rotation of the conveyance roller and pressed against the conveyance roller,
the nip width of contact between the first driven roller surface and the conveyance roller being different from the nip width of contact between the second driven roller surface and the conveyance roller.

2. The printing device described in claim 1, further comprising:
a paper guide that contacts an edge of the recording paper in the direction of the axis of rotation, and guides the recording paper in a predetermined conveyance direction.

3. The printing device described in claim 1, wherein:
the first driven roller and the second driven roller each have a roller body with an outside surface; and
the hardness of the roller body of the first driven roller, and the hardness of the roller body of the second driven roller, are different.

4. The printing device described in claim 1, wherein:
the coefficient of friction of the roller surface of the first driven roller, and the coefficient of friction of the roller surface of the second driven roller, are different.

5. The printing device described in claim 1, wherein:
the roller diameter of the first driven roller, and the roller diameter of the second driven roller, are different.

6. The printing device described in claim 1, further comprising:
a first pressure mechanism that pushes the first driven roller with a first pressure against the conveyance roller; and
a second pressure mechanism that pushes the second driven roller with a second pressure against the conveyance roller;
the first pressure and the second pressure being different.

7. A printing device described in claim 2, further comprising:
a first pressure mechanism that pushes the first driven roller with a first pressure against the conveyance roller; and
a second pressure mechanism that pushes the second driven roller with a second pressure against the conveyance roller;
the first driven roller being disposed on one side of the second driven roller in the direction of the axis of rotation;
the first driven roller and the second driven roller each having a roller body with an outside surface;
the hardness of the roller body of the first driven roller being lower than the hardness of the roller body of the second driven roller;
the first pressure being greater than the second pressure;
the area of contact between the surface of the first driven roller and the conveyance roller being greater than the area of contact between the surface of the second driven roller and the conveyance roller; and
the paper guide being disposed upstream in the conveyance direction from the conveyance roller in contact with the edge of the recording paper on one side in the direction of the axis of rotation.

8. The printing device described in claim 1, wherein:
the printhead is disposed downstream in the conveyance direction from the conveyance roller.
